(19) United States
(12) Patent Application Publication
(10) Pub. No.: US 2023/0065396 A1
(43) Pub. Date: Mar. 2, 2023

(54) PALLET WITH GRIPPER ASSEMBLY

(71) Applicant: ATS Automation Tooling Systems Inc., Cambridge (CA)

(72) Inventors: David Mothersbaugh, Cambridge (CA); Maciej Ruchala, Cambridge (CA); Marc Harvala, Cambridge (CA); Blake Garner, Cambridge (CA); Alexander John LaBrash, Cambridge (CA)

(21) Appl. No.: 17/896,248

(22) Filed: Aug. 26, 2022

Related U.S. Application Data
(60) Provisional application No. 63/238,589, filed on Aug. 30, 2021.

(51) Int. Cl. B65D 19/44

(52) U.S. Cl. CPC B65D 19/44; B65D 2519/00815; B65D 2519/00293

(57) ABSTRACT

A pallet, including a support platform having an upper end and a lower end opposite the upper end, and a vertical axis extending between the upper end and the lower end. The pallet also including a gripper assembly secured to the support platform, the gripper assembly including at least three discrete and spaced-apart tracks, each track extending out from the vertical axis and supporting a gripper finger operable to move along the track between a first position and a second position, the second position being farther from the vertical axis than the first position. Wherein each gripper finger is configured to extend out above the upper end of the support platform in each of the first position and the second position.

### FIELD

The specification relates generally to transporting, and more specifically to pallets.

### BACKGROUND

U.S. Pat. No. 10,404,027 to Porter (“Porter”) purports to disclose a pallet, manufacturing system, and method for transporting and assembling different electrical connectors. The pallet includes first and second jaw assemblies spaced apart from a connector support. The jaw assemblies include jaw plates with gripping edges that form a contoured opening therebetween. As the jaw assemblies move toward one another, dimensions of the contoured opening decrease such that the gripping edges contact and grip an electrical connector placed in the contoured opening. The jaw assemblies are connected to each other by a synchronization device that synchronizes motion of the jaw assemblies and centers the jaw assemblies about an alignment point on the pallet. The pallet accommodates a number of different sizes and/or types of electrical connectors.

U.S. Pat. No. 7,044,066 to Miller (“Miller”) purports to disclose a pallet including a frame and at least one rail secured to the frame. The rail has a slot which slidably receives a pin mechanism. The pin mechanism includes a pallet pin that is moveable along the entire length of the slot, wherein the pallet pin is moveable between a position flush with the frame to a position substantially perpendicular with respect to the frame.

U.S. Pat. No. 5,735,219 to Kirker et al. (“Kirker”) purports to disclose an open base adjustable pallet for supporting work pieces comprising: at least one carriage rod; a first support member mounted for travel along the carriage rod, the first support member including (a) a torsion spring having a helical portion which encircles the carriage rod and engages the carriage rod when the spring is relaxed and disengages from the second carriage rod when the second spring is compressed; and a second support member mounted on the of carriage rod, wherein the first support member is capable of being adjusted along of carriage rod relative to the second support member, thereby enabling the pallet to receive work pieces of differing sizes.

U.S. Pat. No. 7,077,067 to Bodde et al. (“Bodde”) purports to disclose an adjustable hold-down assembly for securely holding heavy and/or bulky goods such as automobile seats to a shipping pallet for transportation thereof. The shipping pallet has a base and a hold-down assembly and which has a cross-bar positioned between two securing posts that are movably attached to the base. The cross-bar is configured for rotational movement relative to the base and linear movement with respect to the securing posts.

### SUMMARY

The following summary is intended to introduce the reader to various aspects of the applicant's teaching, but not to define any invention.

According to some aspects, there is provided a pallet, comprising a support platform having an upper end and a lower end opposite the upper end, and a vertical axis extending between the upper end and the lower end; and a gripper assembly secured to the support platform, the gripper assembly including at least three discrete and spaced-apart tracks, each track extending out from the vertical axis and supporting a gripper finger operable to move along the track between a first position and a second position, the second position being farther from the vertical axis than the first position, and wherein each gripper finger is configured to extend out above the upper end of the support platform in each of the first position and the second position.

In any example, it may be that the gripper fingers are operable to be moved synchronistically.

In any example, it may be that the gripper fingers are operable to be driven by a common drive unit.

In any example, it may be that the pallet further comprises a drive input member arranged to receive an output from the common drive unit, the drive input member coupled to each gripper finger of the at least three gripper fingers to drive the gripper finger between the first position and the second position.

In any example, it may be that each of the tracks includes a rail and a drive belt on the rail, and the drive input member is coupled to the drive belts to drive each of the at least three gripper fingers between the first position and the second position.

In any example, it may be that the drive belt is a chain.

In any example, it may be that the drive input member is coupled to each drive belt adjacent the vertical axis.

In any example, it may be that the drive input member includes a post extending along the vertical axis.

In any example, it may be that the post is a sprocket post engaging the drive belts.

In any example, it may be that the drive belts are vertically spaced along the sprocket post.

In any example, it may be that the drive input member is arranged to receive the output from the common drive unit at the lower end of the support platform.

In any example, it may be that the drive input member extends though the support platform to the lower end of the support platform.

In any example, it may be that the drive input member includes a drive unit coupling end at the lower end of the support platform.

In any example, it may be that each track includes a first end adjacent the vertical axis and a second end opposite the first end, the second end being farther from the vertical axis than the first end

In any example, it may be that each track extends perpendicular to the vertical axis.

In any example, it may be that the at least three tracks extend in a common plane.

In any example, it may be that the tracks are equally spaced about the vertical axis.

In any example, it may be that the first and second positions are radially spaced from the vertical axis, and the gripper assembly is configured as a chuck to hold a load on the pallet.

In any example, it may be that each gripper finger includes a low-friction gripping surface.

In any example, it may be that each gripper finger includes a first gripping surface directed towards the vertical axis and a second gripping surface directed away from the vertical axis.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a top perspective view of a pallet;

FIG. 2 is a top perspective view of the pallet of FIG. 1 with removeable plates of a track housing removed;

FIG. 3 is a partially exploded view of a track of the pallet of FIG. 1;

FIG. 4 is a partially exploded view of a drive input member of the pallet of FIG. 1;

FIG. 5 is a bottom perspective view of a gripper assembly of the pallet of FIG. 1;

FIG. 6 is a top perspective view of a support platform of the pallet of FIG. 1; and,

FIG. 7 is a side view of the gripper assembly of the pallet of FIG. 1.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or process described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

Although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the examples described herein may be practiced without these specific details. In other instances, well-known methods, procedures, and components have not been described in detail so as not to obscure the examples described herein.

As used herein, the wording “and/or” is intended to represent an inclusive—or. That is, “X and/or Y” is intended to mean X or Y or both, for example. As a further example, “X, Y, and/or Z” is intended to mean X or Y or Z or any combination thereof.

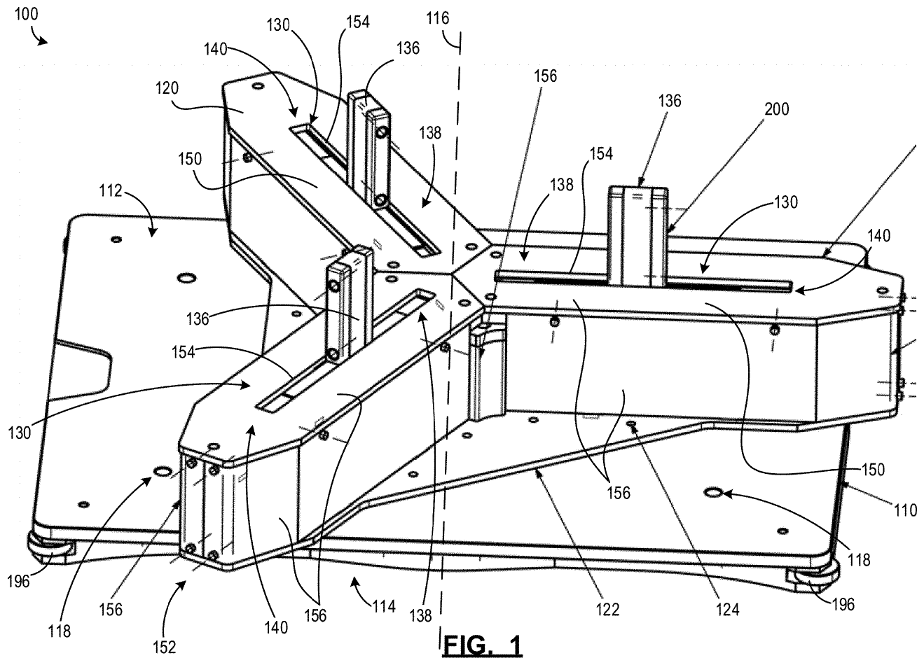

Referring to FIG. 1, illustrated is an exemplary pallet 100. The pallet 100 includes a support platform 110. The support platform 110 has a platform upper end 112 and a platform lower end 114. The platform lower end 114 is opposite the platform upper end 112. A vertical axis 116 extends between the platform upper end 112 and the platform lower end 114.

The platform upper end 112 is adapted to support a load and/or a further component of the pallet 100. In the illustrated example, the platform upper end 112 includes upper end apertures 118 to receive fasteners. For example, a threaded fastener or cord may be secured to the support platform 110 via the upper end apertures 118 and used to secure a further component of the pallet 100.

In the illustrated example, a gripper assembly 120 is secured to the support platform 110. The gripper assembly 120 may be secured to the support platform 110 in any suitable way (e.g., rigidly) such that the gripper assembly 120 may hold a load that is loaded onto the pallet 100. As exemplified, the gripper assembly 120 may be secured to the support platform 110 via fasteners (e.g., bolts) received in upper end apertures 118. The exemplary gripper assembly 120 includes a flange 122 with gripper apertures 124 to be aligned with upper end apertures 118 to receive fasteners therethrough (e.g., so that the parts may be bolted together).

The platform lower end 114 is adapted to rest on an environmental surface, such as a conveyor belt, a shop floor, or a pallet base to which the pallet 100 is secured. The platform lower end 114 may include, e.g., lower end apertures to receive fasteners to hold the support platform 110 to the pallet base, or feet or pads to facilitate use on the environmental surface.

The gripper assembly 120 includes at least three discrete and spaced-apart tracks 130. Each track 130 extends out from the vertical axis 116. Each track 130 supports a gripper finger 136. Each gripper finger 136 is operable to move along the corresponding track 130 between a first position and a second position, the second position being farther from the vertical axis 116 than the first position.

While the tracks 130 may be arranged in various configurations, in some examples the gripper assembly 120 is configured as a chuck. The gripper fingers 136 are configured to move radially in and out to hold a load on the pallet 100. In some examples, the first and second positions of the gripper fingers are radially spaced from (i.e., relative to) the vertical axis 116.

In some examples each track 130 includes a first end 138 adjacent the vertical axis 116 and a second end 140 opposite the first end 138, the second end 140 being farther from the vertical axis 116 than the first end 138. In some examples, each track 130 extends perpendicular to the vertical axis 116 (i.e., the track 130 or a projection of the track 130 intersects the vertical axis 116 at about a 90 degree angle). In some examples, as in the illustrated example, the tracks 130 extend in a common plane. In some examples, as in the illustrated example, the tracks 130 are equally spaced about the vertical axis 116 (i.e., spaced by 120 degrees for three tracks 130, 90 degrees for four tracks 130, etc.).

Each gripper finger 136 is configured to extend out above the upper end 112 of the support platform 110 in each of the first position and the second position. The gripper fingers 136 extend above the upper end 112 to hold a load that is loaded onto the pallet 100.

The illustrated gripper assembly 120 is shown as a separate body secured to (e.g., bolted to) an outer surface (e.g., a top surface) of the support platform 110, however it will be understood that in some examples the gripper assembly 120 may be otherwise secured to support platform 110. For example, the gripper assembly 120 may be integrated into the support platform 110, with, e.g., an upper plate of the support platform extending above the tracks 130 provided the gripper fingers 136 extend above the upper end 112.

The pallet 100 includes a load-bearing surface 150 for supporting a load. The gripper fingers 136 extend above the load-bearing surface 150 such that the gripper fingers 136 are able to grip a load that is resting on the load-bearing surface 150. In the illustrated example, the load-bearing surface 150 is provided on the gripper assembly 120, however it will be understood that in some examples the load-bearing surface 150 may be provided on the support platform 110 (e.g., if the gripper assembly 120 is integrated into the support platform 110).

It will be understood that the tracks 130 and gripper fingers 136 could be exposed to the environment. However, in some examples the gripper assembly 120 includes a protective housing. As exemplified in FIG. 1, the gripper assembly 120 includes a track housing 152 enclosing the tracks 130. Slots 154 in the track housing 152 are provided to permit movement of the gripper fingers 136 extending above the load-bearing surface 150. The track housing 152 is formed of removable plates 156 (e.g., held on be removeable fasteners, such as treaded fasteners) to allow for easy access to an interior of the track housing 152. The load-bearing surface 150 may be a surface of one or more of the removeable plates 156.

In use, a load may be placed on the load-bearing surface 150 when the gripping fingers 136 are either in the second positions so that the load may be received between them or in the first positions so that the load may be an object received around them. For example, the pallet 100 may be used to transport a metal plate, and the metal plate may be placed between the gripper fingers 136. In another example, the pallet 100 may be used to transport a disc with a central aperture, and the gripper fingers 136 may be positioned within the central aperture. The load received on the load-bearing surface 150 may be gripped by moving the gripper fingers 136 into engagement with the load. For example, the gripper fingers 136 may be moved in from the second positions to bear against an outer perimeter of the load, or the gripper fingers 136 may be moved out from the first positions to bear against an inner surface of the load that surrounds the central aperture.

The load may be a heavy load. For example, the load may be more than 100 kg, more than 200 kg, more than 250 kg, or about 275 kg. The pallet 100 may be configured to support the heavy load. For example, the pallet 100 may be formed of high-strength materials (e.g., metal) to support the heavy load.

In use, the pallet 100 with the gripped load may be moved from one location to another. For example, the pallet 100 may be moved from one station of a facility to another. The pallet 100 may be moved from a milling station at which the load is cut and placed on the pallet 100 (e.g., the load may be a single disc cut from a rod, or a plurality of discs cut from a rod) to a cleaning station to remove debris (e.g., machining oil) and/or to a testing station to test the quality of the load (e.g., to a water or ultrasonic tank where the load is removed from the pallet 100 and moved into the tank to be tested). The gripper fingers 136 bear against the load during transit to prevent the load from moving (i.e., laterally) on the pallet 100. The gripper fingers 136 may be loose when not joined to a drive unit, as discussed further below.

The pallet 100 may be configured to pick up a load having any outer diameter between about 10 cm to about 100 cm. Accordingly, the tracks 130 extend out from the vertical axis by an amount sufficient to grasp such an item, either by grasping the perimeter or by gripping an interior surface surrounding an aperture. In some examples, the tracks 130 have a length between about 5 cm and about 60 cm, between about 5 cm and about 50 cm, between about 10 cm and about 50 cm, or between about 20 cm and about 40 cm.

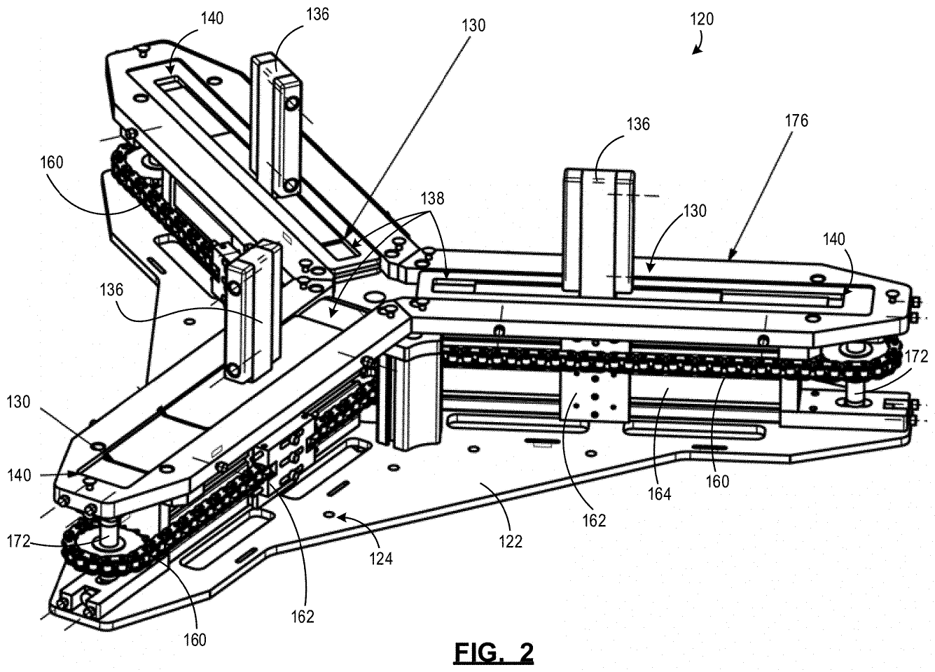

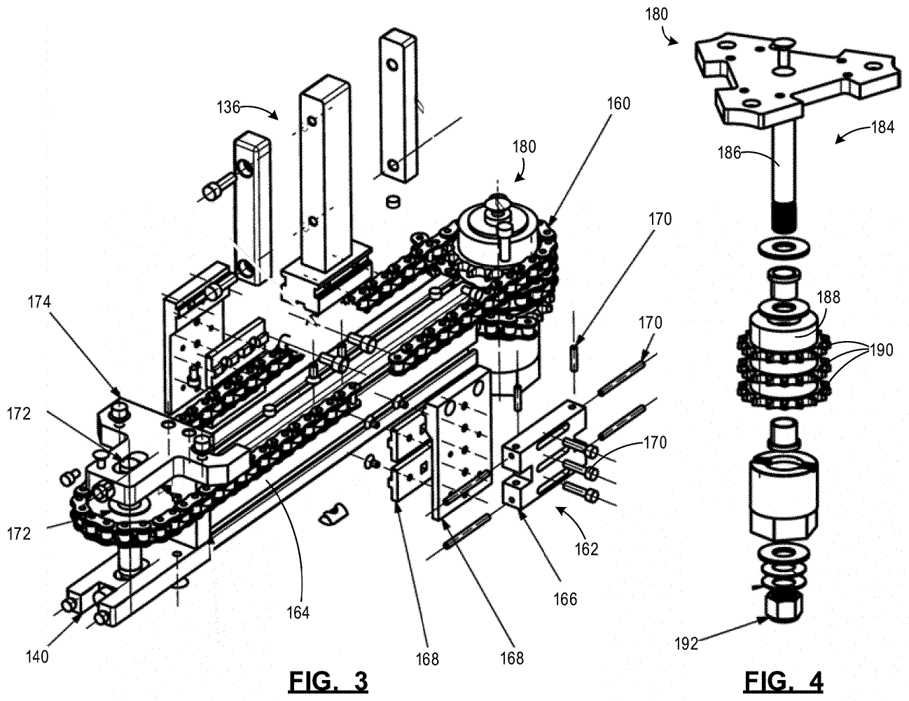

Referring now to FIG. 2, the gripper assembly 120 is shown without the removeable plates 156. While the gripper fingers 136 may be moved in various ways (e.g., via linear rams, ball screws etc.), in some examples the tracks 130 each include a drive belt 160 configured to move the gripper finger 136. In the illustrated example, each gripping finger 136 includes a mount 162 carried by a rail 164 of the track 130. The drive belt 160 is secured to the mount 162 to move the mount 162 along the rail 164. As illustrated in FIG. 3, the drive belt 160 may be secured to the mount 162 via an attachment block 166 held to backing plates 168 of the mount 162 by pins 170.

Referring again to FIG. 2, the drive belt 160 may be shaped to be carried by one or more sprockets. In the illustrated example, the belt is a chain. End sprockets 172 guide the belt 160 at the second end 140 of the track 130. The end sprockets 172 are held in position by support plates 174 (FIG. 3) secured to a frame 176 of the gripper assembly 120.

While each gripper finger 136 could be operable independently in some examples, moving the gripper fingers 136 at the same time and/or by the same amount (e.g., synchronistic movement) may allow for better gripping performance. For example, synchronistic movement may allow a load to be centered more easily. In some examples, the gripper fingers 136 are operable to be moved synchronistically. In some examples, the gripper fingers 136 are operable to be driven by a common drive unit. For example, each of the drive belts 160 may be coupled to a common drive unit to be driven by the drive unit. A common drive unit may facilitate synchronistic movement.

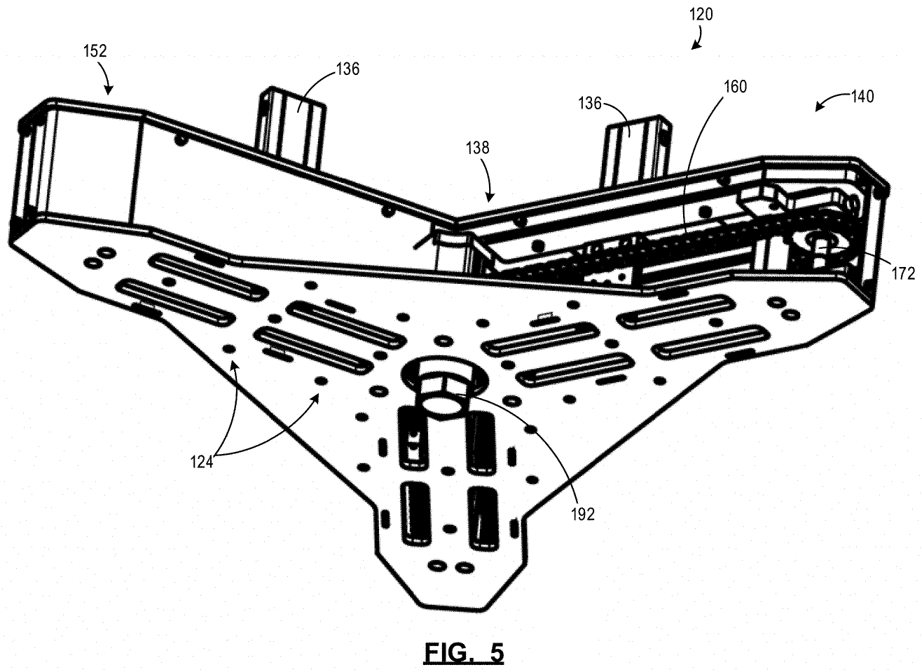

Referring now to FIGS. 3 and 4, each gripper finger 136 is coupled to a common drive input member 180. The common drive input member 180 is coupled to each gripper finger 136 (e.g., via the drive belt 160 in the illustrated example) to drive the gripper finger between the first and second positions. In some examples, the drive input member 180 is coupled to each drive belt 160 adjacent the vertical axis 116. As exemplified, each drive belt 160 is carried at the first end 138 of the track 130 by the drive input member 180.

The drive input member 180 is arranged to receive an output from the common drive unit. The output of the common drive unit may be received in various ways in various examples. In some examples, the drive input member may be an output shaft of a servo unit. However, in the illustrated example the drive input member 180 includes a post 184. The drive belts 160 are each arranged around the post 184 to be moved by rotation of the post about the post's longitudinal axis. In the illustrated example, the post 184 extends along the vertical axis 116. The post 184 is a sprocket post engaging the drive belts 160. The sprocket post includes a shaft 186 and a sprocket member 188 rotatably mounted to the shaft 186. The sprocket member 188 has a path 190 for each drive belt 160. The drive belts 160 are vertically spaced along the sprocket post. The drive belts are carried by the paths 190, and the paths 190 are vertically spaced. In the illustrated example, the paths 190 are regularly spaced along the post 184.

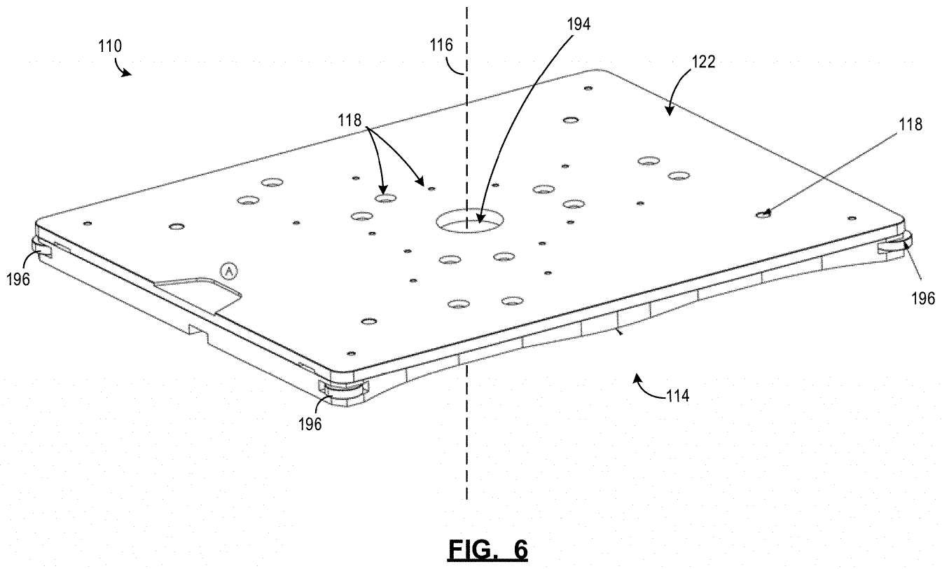

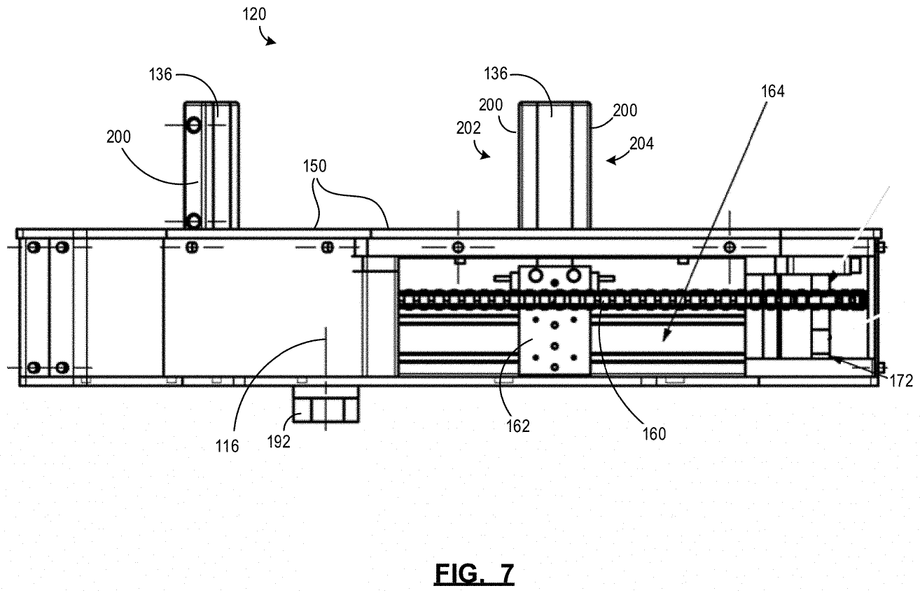

Referring now to FIGS. 5 and 6, in some examples the drive input member 180 is arranged to receive the output from the common drive unit at the lower end 114 of the support platform 110. The drive input member 180 may extend out of an end of the gripper assembly other than the end that the gripper fingers 136 extend out of (i.e., a side or bottom end). As exemplified, the drive input member 180 extends out an end that is opposite the end that the gripper fingers 136 extend out of. The gripper fingers 136 extend out of the top end of the gripper assembly 120. The drive input member 180 extends out the lower end of the gripper assembly 120. The extension of the drive input member 180 out of the gripper assembly 120 away from the gripper fingers 136 may allow the common drive unit to be coupled to the drive input member 180 away from the gripper fingers.

As exemplified, the drive input member 180 includes a drive unit coupling 192 at which the drive unit may be coupled to drive the drive input member 180. In the illustrate example the gripper assembly is a nut-driven assembly. The drive unit coupling 192 is a nut with a plurality of flat outside surfaces. In some examples, the drive unit coupling 192 is available to be engaged by a drive unit at a station at which the pallet has arrived, and the pallet may move between stations with the drive unit coupling 192 being engaged by different drive units at different stations.

The drive input member 180 may extend through the support platform 110. As exemplified, the drive unit coupling 192 is at the lower end of the support platform 110. The gripper fingers 136 and the load-receiving surface 150 are across the support platform 110 from the drive unit coupling 192. The drive unit coupling 192 extends out a lower end of the gripper assembly and through a drive aperture 194 in the support platform 110.

As also exemplified in FIG. 6, the support platform 110 may, in some examples, include bumper members 196. The bumper members 196 may be arranged on the outer perimeter of the support platform 110, such as at corners of a rectangular platform. The bumper members 196, as illustrated, are rollers rotationally mounted to a body of the support platform 110.

Referring now to FIG. 7, each gripper finger 136 may include at least one gripping surface 200. The gripping surface 200 is arranged on the gripping finger 136 to bear against a load on the load-receiving surface 150 when the gripping finger 136 is moved along the track 130. As exemplified, in some examples each gripper finger includes a first gripping surface 202 directed towards the vertical axis 116 and a second gripping surface 204 directed away from the vertical axis 116. First and second gripping surfaces 202, 204 may allow the gripping finger 136 to be used to hold either an outside perimeter of a load or an inside surface surrounding a central aperture.

A gripping surface 200 may be a low-friction gripping surface. The gripping surface 200 may also or alternatively be a low wear rate surface when run against mating metal surfaces (e.g., titanium or nickel discs). The gripping surface 200 may be, e.g., a nylon-surface. The gripping surface 200 may be a surface of a pad or coating mounted on a gripping finger 136 formed of another material (e.g., steel).

The present invention has been described here by way of example only. Various modification and variations may be made to these exemplary embodiments without departing from the scope of the invention, which is limited only by the appended claims.

1. A pallet, comprising:
a. a support platform having an upper end and a lower end opposite the upper end, and a vertical axis extending between the upper end and the lower end; and
b. a gripper assembly secured to the support platform, the gripper assembly including at least three discrete and spaced-apart tracks, each track extending out from the vertical axis and supporting a gripper finger operable to move along the track between a first position and a second position, the second position being farther from the vertical axis than the first position, and
c. wherein each gripper finger is configured to extend out above the upper end of the support platform in each of the first position and the second position.

2. The pallet of claim 1, wherein the gripper fingers are operable to be moved synchronistically.

3. The pallet of claim 1, wherein the gripper fingers are operable to be driven by a common drive unit.

4. The pallet of claim 1, further comprising a drive input member arranged to receive an output from the common drive unit, the drive input member coupled to each gripper finger of the at least three gripper fingers to drive the gripper finger between the first position and the second position.

5. The pallet of claim 1, wherein each of the tracks includes a rail and a drive belt on the rail, and the drive input member is coupled to the drive belts to drive each of the at least three gripper fingers between the first position and the second position.

6. The pallet of claim 5, wherein the drive belt is a chain.

7. The pallet of claim 5, wherein the drive input member is coupled to each drive belt adjacent the vertical axis.

8. The pallet of claim 4, wherein the drive input member includes a post extending along the vertical axis.

9. The pallet of claim 8, wherein the post is a sprocket post engaging the drive belts.

10. The pallet of claim 9, wherein the drive belts are vertically spaced along the sprocket post.

11. The pallet of claim 4, wherein the drive input member is arranged to receive the output from the common drive unit at the lower end of the support platform.

12. The pallet of claim 11, wherein the drive input member extends though the support platform to the lower end of the support platform.

13. The pallet of claim 12, wherein the drive input member includes a drive unit coupling end at the lower end of the support platform.

14. The pallet of claim 1, wherein each track includes a first end adjacent the vertical axis and a second end opposite the first end, the second end being farther from the vertical axis than the first end

15. The pallet of claim 1, wherein each track extends perpendicular to the vertical axis.

16. The pallet of claim 1, wherein the at least three tracks extend in a common plane.

17. The pallet of claim 1, wherein the tracks are equally spaced about the vertical axis.

18. The pallet of claim 1, wherein the first and second positions are radially spaced from the vertical axis, and the gripper assembly is configured as a chuck to hold a load on the pallet.

19. The pallet of claim 1, wherein each gripper finger includes a low-friction gripping surface.

20. The pallet of claim 1, wherein each gripper finger includes a first gripping surface directed towards the vertical axis and a second gripping surface directed away from the vertical axis.
